(19) United States
(12) Patent Application Publication
(10) Pub. No.: US 2021/0354953 A1
(43) Pub. Date: Nov. 18, 2021

(54) NON-CONTACT CONTROL SYSTEM

(71) Applicant: UNISMART TECHNOLOGY CO., LTD., Taichung City (TW)

(72) Inventors: GEENG-JEN SHEU, Taichung City (TW); WEN-CHING CHEN, Taichung City (TW); CHIEN-YI CHEN, Taichung City (TW); ZHENG-YAO WANG, Taichung City (TW)

(21) Appl. No.: 17/319,059

(22) Filed: May 12, 2021

(30) Foreign Application Priority Data
May 14, 2020 (TW) 109115996

(51) Int. Cl. B66B 1/34; B66B 1/46; H04W 4/80

(52) U.S. Cl. CPC B66B 1/3461; B66B 1/3453; B66B 2201/4653; H04W 4/80; B66B 2201/4638; B66B 1/468

(57) ABSTRACT

A non-contact control system includes a control circuit board, a Beacon Gateway, and a mobile electronic device with the original structure of the device to be controlled. The main feature is that when the application of the mobile electronic device is activated, the mobile electronic device displays a control screen for the user to click to control the actuating of the main body. Therefore, the user does not need to touch physical buttons and make a sound in the control operation, so direct contact and droplet infection can be avoided.

### BACKGROUND

### Field of the Invention

The present invention relates to a non-contact control system, and more particularly to a non-contact control system using mobile electronic devices.

### Related Prior Art

Due to the high development of industry and commerce, the field of human life has gradually expanded, and the space for human activities has also been reduced. Therefore, high-rise buildings have appeared. The elevator is the product of the era under this situation, because it can provide convenience for human beings to go up and down tall buildings. However, during the use of the buttons or keys on the conventional direct touch switch by touch, and when a user who has been infected with epidemic diseases (including oral contact infectious diseases) use their fingers to press the elevator buttons in public spaces (such as department stores or hospitals, etc.), germs will remain on the surface of the buttons. After the next user touches and presses the buttons, the germs can be quickly transmitted to a third person through the medium of the buttons, resulting in a public health crisis that spreads the infection.

In addition, places where germs are quickly transmitted to a third person due to touch-pressing in human life include taking a bus, entering places with access control, and so on. Before getting off the bus, the passenger must ring the bell to remind the driver to stop at the next stop in order to get off the bus. However, when the passenger presses the bell, he/she will be exposed to the germs remaining on the surface of the bell, which will cause a public health crisis that expands the infection. Similarly, when a visitor wants to enter a place with access control, there are at least three chances for direct contact with germs. Firstly, the visitor goes to the management room for visitor registration, and fills in the information in the visitor register with a pen, and then exchanges certificates with the administrator for the access control card (buckle), the visitor will be exposed to the residue germs on the surface of the access control card (buckle) when he takes the access control card (buckle); the third is to take the access control card (buckle) for induction of the access control system, because the induction process is a close proximity contact (such as NFC), so it is likely to touch the access control switch of the access control system, the visitor will therefore come into contact with germs remaining on the surface of the access control switch.

Accordingly, how to develop a non-contact control system to reduce direct contact infection of germs and avoid the expansion of cluster infection is the motivation of the present invention.

### SUMMARY

One object of the present invention is to provide a non-contact control system, which mainly reduces the risk of infection caused by direct contact and the expansion of group infections.

Another object of the present invention is to provide a non-contact control system, which can be mainly applicable to various existing control devices, such as elevator control devices, bus getting off reminder control devices, access control devices. Non-contact control can be performed without changing the existing control device.

Another object of the present invention is to provide a non-contact control system, which mainly uses short-distance wireless transmission between the Beacon Gateway and the Bluetooth module of the mobile electronic device. Therefore, non-contact control can be carried out without the Internet, which improves the convenience and universal applicability.

To achieve the abovementioned objects, a non-contact control system is provided by the invention and suitable for controlling a device, the device includes an actuating body and a control module, the control module includes a proximal control switch, wherein the proximal control switch is capable of generating a proximal control signal for controlling actuation of the actuating body, the non-contact control system comprises: a control circuit board electrically connected to the control module for converting a distal control signal into the proximal control signal; a Beacon Gateway communicatively connected to the control circuit board, and continuously broadcasting an identification packet and an scanning a drive packet; and a mobile electronic device communicatively connected to the Beacon Gateway, provided with an application, and including a Bluetooth module connected to the application, wherein the Bluetooth module is used for continuously scanning the identification packet and broadcasting the drive packet.

wherein the identification packet and the drive packet are both in a Bluetooth low energy packet format, the identification packet includes a first universally unique identifier, the first universally unique identification code contains number of the device, and the drive packet includes a second universally unique identifier;

in this way, when the application of the mobile electronic device is activated, and the Bluetooth module scans the identification packet broadcasted by the Beacon Gateway, the application of the mobile electronic device analyzes information contained in the identification packet and then displays the control screen of the device with the number, the control screen includes a distal control switch corresponding to the proximal control switch, when the distal control switch is pressed, the drive packet containing the distal control signal is generated, and the drive packet is broadcasted by the Bluetooth module, when the Beacon Gateway scans the drive packet and confirms that the second universally unique identifier is correct, the distal control signal contained in the drive packet is transmitted to the control circuit board, and the control circuit board converts the distal control signal into the proximal control signal corresponding to the proximal control switch, and transmits the proximal control signal to the control module to control the actuating body to act.

The effect of the present invention is: the present invention proposes a non-contact control system, which is composed of the control circuit board, the Beacon Gateway and the mobile electronic device with various desired control devices. The main feature is that when the application of the mobile electronic device is activated, and the mobile electronic device displays a control screen for the user to click to control the action of the actuating body. According to this, the present invention does not require the user to touch the physical buttons and make a sound in the control operation, so it can avoid direct contact and droplet infection. On the other hand, the present invention uses short-distance wireless transmission between the Beacon Gateway and the Bluetooth module of the mobile electronic device, so that non-contact control can be carried out without the Internet, which improves the convenience and universal applicability. Furthermore, when the present invention is installed, it only needs to be electrically connected in parallel to the existing proximal control devices of the various desired control devices through the control circuit board, and out non-contact control can be achieved without changing the main control systems of the existing desired control devices, so it can adapt to the new and old architectures of various existing control devices.

In addition, because the Beacon Gateway continuously broadcasts an identification packet, the identification packet includes a first UUID, and the first UUID contains the number of the device. Therefore, when the application of the mobile electronic device is activated and the Bluetooth module of the mobile electronic device scans the identification packet, it reads and confirms the device number of the UUID contained in the identification packet, and after the application of the mobile electronic device analyses the information in the identification packet, the control screen of the device with the corresponding number will be displayed. The control screen includes a distal control switch corresponding to the proximal control switch. When the distal control switch is pressed, a drive packet containing the distal control signal is generated, and the drive packet is broadcasted by the Bluetooth module. When the Beacon Gateway scans the drive packet and confirms that the second UUID is correct, then it will send the distal control signal contained in the drive packet to the control circuit board, and the control circuit board converts the distal control signal into a proximal control signal corresponding to the proximal control switch, and transmits the proximal control signal to the control module to control the actuating body of the device with the number to act, without triggering the actions of other devices of the same type. Therefore, the subsequent operation control will control the device with the matching number, and there will be no accidental control of the actuating body of the nearby device of the same type.

In order to make the above-mentioned features and advantages of the present invention more obvious and understandable, the following examples are given. And with the attached drawings, the detailed description is as follows.

### BRIEF DESCRIPTION OF THE DRAWINGS

FIG. 1 is a block diagram of the first embodiment of the present invention;

FIG. 2 is a schematic diagram of the use state of the first embodiment of the present invention;

FIG. 3 is a schematic diagram of the first embodiment of the present invention, showing the state of the mobile electronic device displaying a control screen;

FIG. 4 is a control flowchart of the first embodiment of the present invention;

FIG. 5 is a control flowchart of the second embodiment of the present invention;

FIG. 6 is a block diagram of a third embodiment of the present invention;

FIG. 7 is a schematic diagram of the use state of the third embodiment of the present invention;

FIG. 8 is a schematic diagram of a third embodiment of the present invention, showing a state in which the mobile electronic device displays a control screen;

FIG. 9 is a control flowchart of the third embodiment of the present invention;

FIG. 10 is a block diagram of a fourth embodiment of the present invention;

FIG. 11 is a schematic diagram of the use state of the fourth embodiment of the present invention, showing the state of obtaining the elevator authorization token code;

FIG. 12 is a control flowchart of the fourth embodiment of the present invention;

FIG. 13 is an authentication flow chart of the fourth embodiment of the present invention, showing the flow of user identity authorization authentication;

FIG. 14 is a block diagram of a fifth embodiment of the present invention;

FIG. 15 is a block diagram of a sixth embodiment of the present invention;

FIG. 16 is a schematic diagram of the use state of the sixth embodiment of the present invention;

FIG. 17 is a schematic diagram of the sixth embodiment of the present invention, showing a state in which a mobile electronic device displays a control screen;

FIG. 18 is a control flowchart of the sixth embodiment of the present invention;

FIG. 19 is an authentication flow chart of the sixth embodiment of the present invention, showing the flow of user identity authorization authentication; and

FIG. 20 is a block diagram of the seventh embodiment of the present invention.

### DETAILED DESCRIPTION

Before presenting a detailed description, it should be noted that in the following description, similar component and part names are represented by the same number.

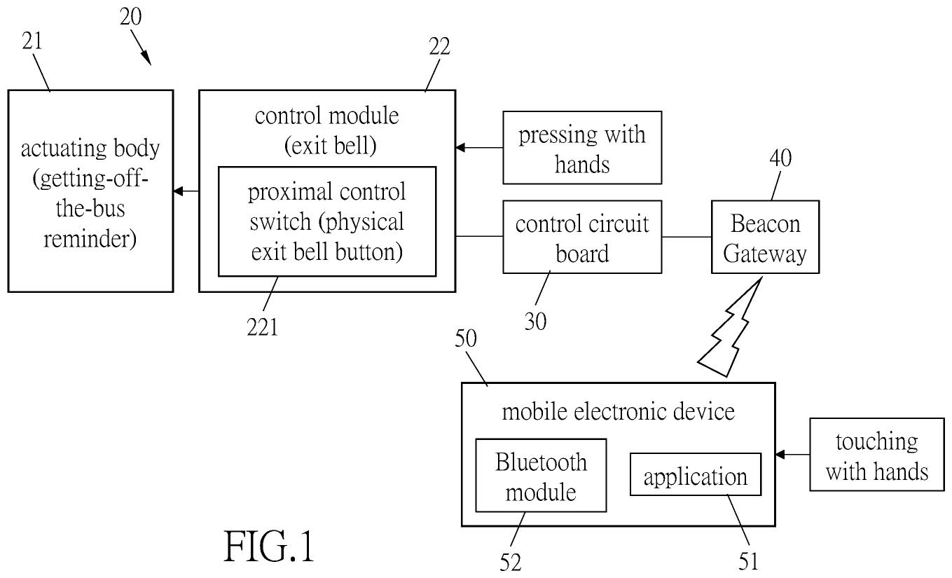

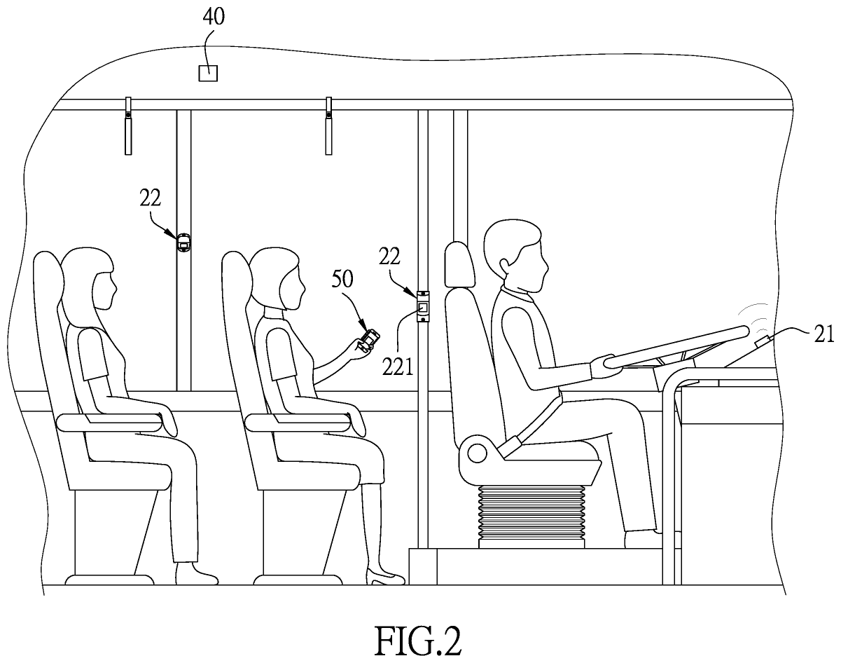

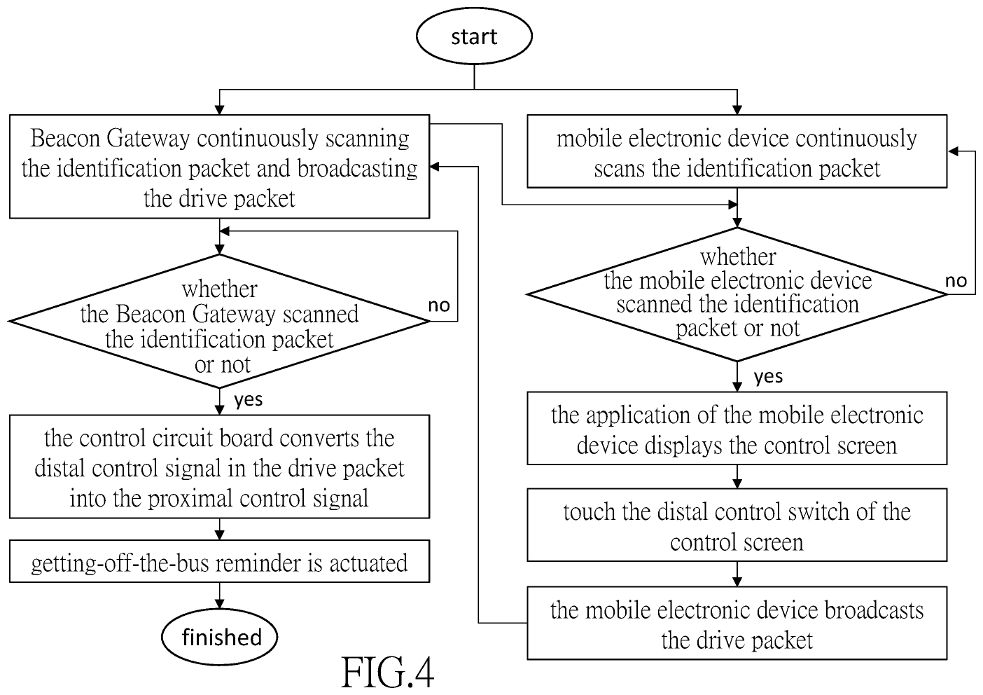

Please refer to FIGS. 1 to 4, the first embodiment of the present invention provides a non-contact control system, suitable for controlling a device 20, the device includes an actuating body 21 and a control module 22. The control module 22 includes a proximal control switch 221, and the proximal control switch 221 can generate a proximal control signal for controlling the actuation of the actuating body 21. In this embodiment, the device 20 is a getting-off-the-bus reminder system for reminding the driver. The actuating body 21 is a getting-off-the-bus reminder for reminding the driver, such as a horn for generating a reminder voice, a buzzer for generating a reminder sound, or an exit lamp for generating a reminder light. The control module 22 is an exit bell, and the proximal control switch 221 is a physical exit bell button. The non-contact control system essentially comprises a control circuit board 30, a Beacon Gateway 40, and a mobile electronic device 50.

The control circuit board 30 is electrically connected to the proximal control switch 221 of the control module 22 for converting a distal control signal into the proximal control signal generated by the proximal control switch 221. In this embodiment, the control circuit board 30 can further convert the distal control signal into a proximal control signal and simultaneously light up the corresponding proximal control switch 221.

The Beacon Gateway 40 is communicatively connected to the control circuit board 30, and continuously broadcasts an identification packet and continuously scans a drive packet. In this embodiment, the identification packet and the drive packet are both in a Bluetooth low energy packet format (Bluetooth Low Energy, referred to as BLE), the identification packet includes a first universally unique identifier (UUID), and the drive packet includes a second universally unique identifier (UUID). Among them, the first universally unique identifier (UUID) contains the number of the bus, so as to avoid controlling the exit bell of other nearby buses.

The mobile electronic device 50 is communicatively connected to the Beacon Gateway 40, provided with an application 51, and includes a Bluetooth module 52 connected to the application 51. The Bluetooth module 52 is used for continuously scanning the identification packet and broadcasting the drive packet; in this embodiment, the mobile electronic device 50 is a smart phone as an example, but not limited to this, and can also be a smart watch, a tablet, a laptop or a wearable device, and the mobile electronic device 50 perform wireless controlling with the control circuit board 30 without an Internet connection.

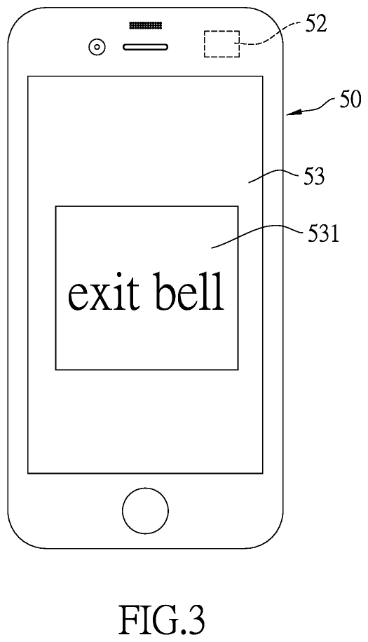

In this way, the user holds the mobile electronic device 50 with the application activated and rides on the bus. Since the Beacon Gateway 40 in the bus continuously broadcasts an identification packet, when the Bluetooth module 52 of the mobile electronic device 50 scans the identification packet broadcasted by the Beacon Gateway 40, and the application 51 determines that the first UUID contained in the identification packet is correct, the application 51 of the mobile electronic device 50 will display a control screen 53. Meanwhile, the control screen 53 displays a distal control switch 531 according to the content of the first UUID contained in the identification packet, and the distal control switch 531 corresponds to the proximal control switch 221, that is, as shown in FIG. 3, the distal control switch 531 is the exit bell button displayed on the control screen 53.

At this time, when the next stop is the user's destination, the user presses the distal control switch 531 displayed on the mobile electronic device 50, and the application 51 dynamically generates the drive packet containing the distal control signal, the distal control signal is the second UUID contained in the drive packet.

Then the application 51 broadcasts the drive packet through the Bluetooth module 52 of the mobile electronic device 50, when the Beacon Gateway 40 on the bus scans the drive packet, and determines that the second UUID contained in the drive packet has the correct distal control signal, the Beacon Gateway 40 will send the distal control signal contained in the drive packet to the control circuit board 30. Then, the control circuit board 30 converts the distal control signal into a corresponding proximal control signal and controls the corresponding proximal control switch 221 to light up, the proximal control signal is then transmitted to the control module 22, so that the control module 22 controls the actuating body 21 to act according to the proximal control signal, that is, generates sound or light to remind the driver to stop at the next stop.

Therefore, the above-mentioned information transmission, determination, verification and operation process are all carried out through the Beacon Gateway 40 in the bus and the Bluetooth module 52 of the mobile electronic device 50. The short distance and continuous broadcasting and scanning between the two achieves the contactless get-off reminder control, which does not require a network connection or a cloud database environment.

Accordingly, the present invention can at least achieve the following effects:

First, because the present invention comprises the control circuit board 30, the Beacon Gateway 40, and the mobile electronic device 50 and is used in combination with the conventional bus driver get-off reminder system, the main feature is that when using a customized application to scan the identification packet broadcasted by the Beacon Gateway 40 of various devices, a control screen 53 will appear on the user's mobile electronic device 50 for the user to click to control the operation of the actuating body 21. According to this, the present invention does not need to touch the physical buttons and emit sound in the control operation, so it can avoid direct contact and droplet infection, and effectively reduce the risk of infection caused by direct contact and the expansion of group infection.

Second, because the present invention utilizes short-distance wireless transmission between the Beacon Gateway 40 and the Bluetooth module 52 of the mobile electronic device 50, non-contact control can be performed without the Internet. That is, the present invention can perform non-contact control under offline conditions to complete the control of the get-off (exit) bell, thereby improving the convenience of use and universal applicability.

Third, during installation, the present invention only needs to be electrically connected to the existing physical button of the exit bell through the control circuit board 30, which is suitable for various existing bus architectures, and non-contact control can be performed without changing the conventional getting off reminder system of the bus. Therefore, it can be applied to the new and old architectures of various existing bus exit (get-off) bells, highlighting the effect of high applicability. Fourth, because the present invention is electrically connected in parallel to the existing physical button of the physical button of the bus via the control circuit board 30, it has two independent parallel functions of the existing physical button contact operation and non-contact operation at the same time.

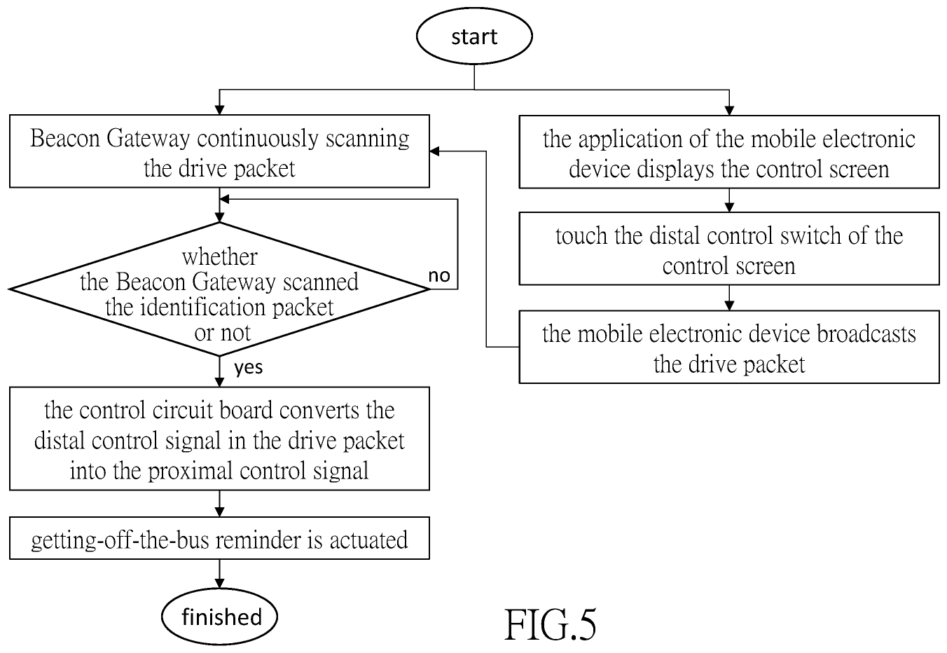

Please refer to FIG. 5, the second embodiment of the present invention provides a non-contact control system, which is different from the first embodiment in that: please also see FIGS. 1 to 3.

The Beacon Gateway 40 will only continuously scan a drive packet, but will not output the identification packet and the first UUID contained in it.

In this way, when the user holds the mobile electronic device 50 with the application 51 activated and takes the bus, the application 51 of the mobile electronic device 50 will directly display the control screen 53, and the control screen 53 will display the distal control switch 531 is for the user to press. After pressing, a drive packet including the distal control signal is generated for the Beacon Gateway 40 to scan, and the subsequent operation mode is the same as that of the first embodiment. Finally, the actuating body 21 can be controlled to act, that is, to generate a sound or light to remind the driver to stop at the next stop.

Accordingly, since the Beacon Gateway 40 only needs to scan a drive packet, the cost of the parts of the Beacon Gateway 40 is effectively reduced.

It is worth noting that in the second embodiment, the user can use the second UUID of the drive packet output by the mobile electronic device 50 and the signal strength indicator (RSSI) received by the scanning of the Beacon Gateway 40 is used to identify the current taken bus (because the RSSI strength is the strongest), so as to avoid erroneously controlling the operation of the actuating body 21 (ie, getting off reminder) of other nearby buses.

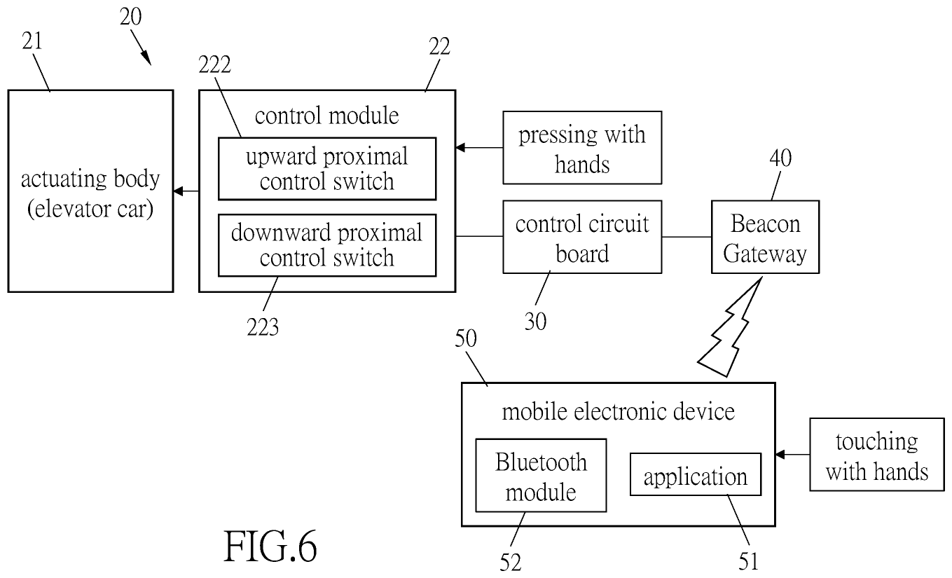

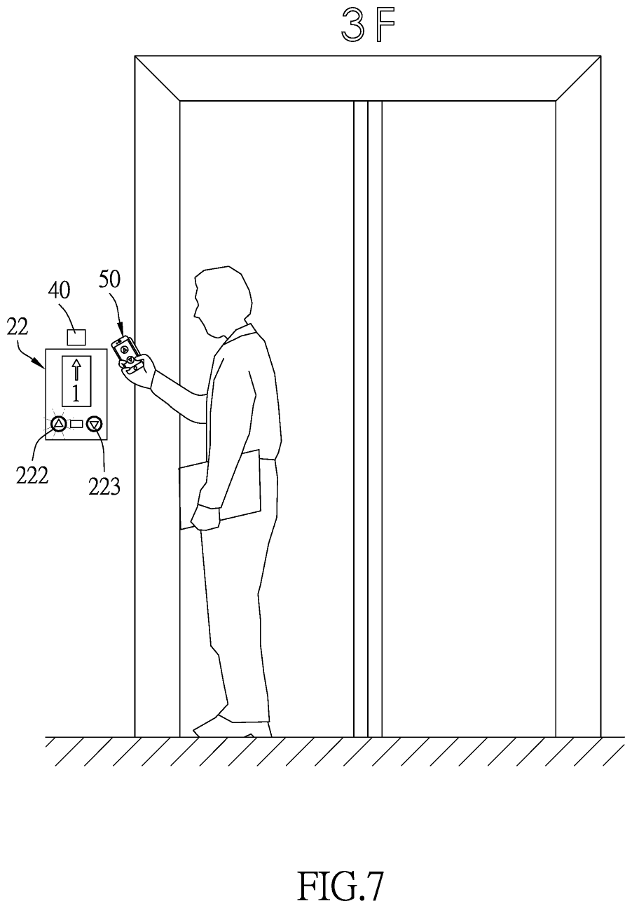

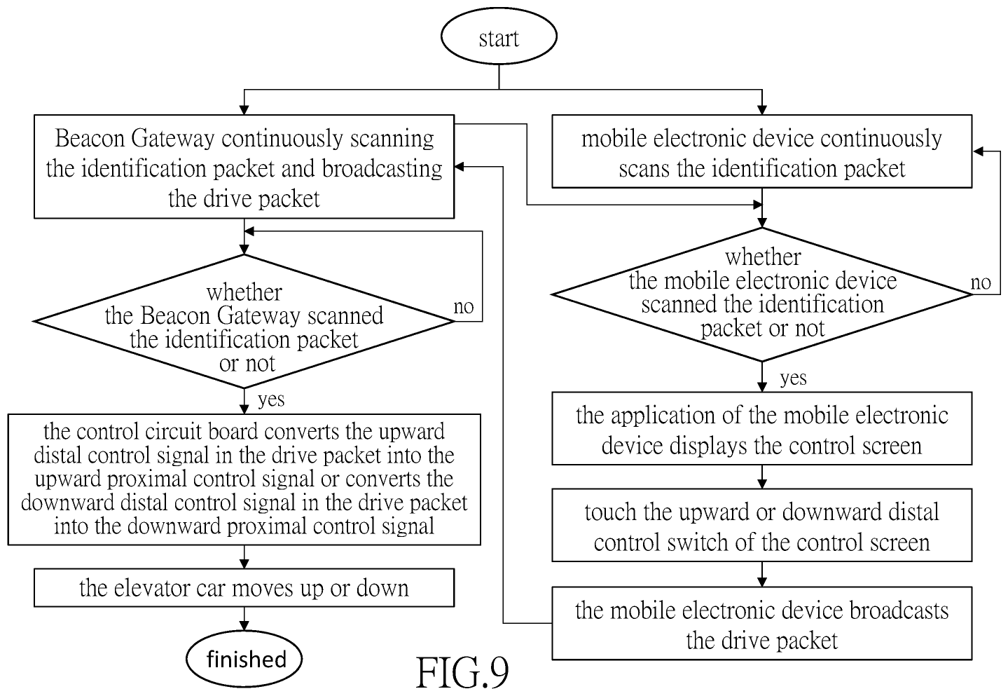

Please refer to FIGS. 6-9, the third embodiment of the present invention provides a non-contact control system. The difference from the first embodiment is that the device 20 of the third embodiment is an elevator car-hailing system. The actuating body 21 is an elevator car; the control module 22 is provided in the elevator landing of each floor, and each of the control modules 22 includes an upward proximal control switch 222 and a downward proximal control switch 223. Therefore, the upward proximal control switch 222 can generate an upward proximal control signal for controlling the actuating body 21 to move upward, and the downward proximal control switch 223 can produce a downward proximal control signal to control the actuating body 21 to move downward. The above is the existing architecture of the elevator car-hailing system. The non-contact control system of the present invention also comprises a control circuit board 30, a Beacon Gateway 40, and a mobile electronic device 50.

There are multiple control circuit boards 30, which are respectively electrically connected to the upward proximal control switch 222 and the downward proximal control switch 223 of the control module 22 of each elevator landing, so as to convert a distal control signal into an upper proximal control signal or a downward proximal control signal. In this embodiment, the control circuit board 30 can further convert the distal control signal into the upward proximal control signal or the downward proximal control signal, and simultaneously light up the corresponding upward proximal control switch 222 or the downward proximal control switch 223.

There are multiple Beacon Gateways 40, which are respectively communicatively connected to the control circuit board 30 of each elevator landing, and continuously broadcast an identification packet and continuously scan a drive packet. In this embodiment, the identification packet and the drive packet are both in the Bluetooth low energy packet format, the identification packet includes a first UUID, and the drive packet includes a second UUID. The first UUID contains the number and floor of the elevator landing, so as to avoid controlling the elevator car of other elevator landings.

The mobile electronic device 50 is communicatively connected to the Beacon Gateway 40 and provided with an application 51, and includes a Bluetooth module 52 connected to the application 51. The Bluetooth module 52 is used for continuous scanning the identification packet and broadcasting the drive packet; in this embodiment, the mobile electronic device 50 is a smart phone as an example, and scan be wirelessly controlled with the control circuit board without Internet connection.

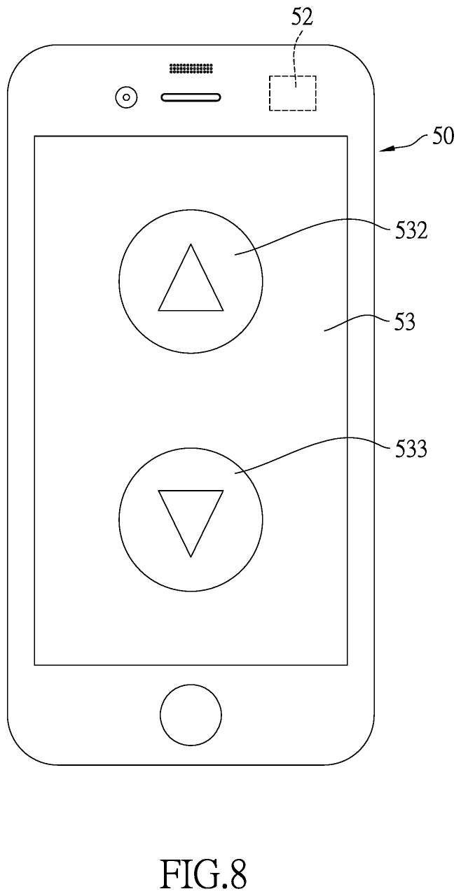

In this way, the user holds the mobile electronic device 50 with the application activated before boarding the elevator, because the Beacon Gateway 40 located at the elevator landing station continuously broadcasts an identification packet, when the Bluetooth module 52 of the mobile electronic device 50 scans the identification packet broadcasted by the Beacon Gateway 40, and the application 51 determines that the first UUID contained in the identification packet is correct, the application 51 of the mobile electronic device 50 displays a control screen 53, as shown in FIG. 8. The control screen 53 displays the upward distal control switch 532 and the downward distal control switch 533 according to the content of the first UUID contained in the identification packet, and the upward distal control switch 532 corresponds to the upper proximal control switch 221, and the downward distal control switch 533 corresponds to the downward proximal control switch 223.

At this time, if the actuating body 21 (ie the elevator car) is on the first floor, and the user is on the third floor and wants to go to a higher floor, the user presses the upward distal control switch 532 display on the mobile electronic device 50. At this time, the application 51 dynamically generates the drive packet including the upward distal control signal. The upward distal control signal is encoded in the second UUID contained in the drive packet.

Then the application 51 broadcasts the drive packet through the Bluetooth module 52 of the mobile electronic device 50, when the Beacon Gateway 40 of the elevator landing where the user is located scans the drive packet, and the Beacon Gateway 40 determines that the second UUID contained in the drive packet includes the correct upward distal control signal, the Beacon Gateway 40 transmits the upward distal control signal contained in the drive packet to the control circuit board 30. Then, the control circuit board 30 converts the upward distal control signal into a corresponding upward proximal control signal, and controls the corresponding upward proximal control switch 222 to light up, the upward proximal control signal is transmitted to the control module 22, and then the control module 22 controls the actuating body 21 to operate according to the upward proximal control signal, that is, the elevator car is controlled to move from the 1st floor to the 3rd floor, so as to complete the non-contact car-hailing control.

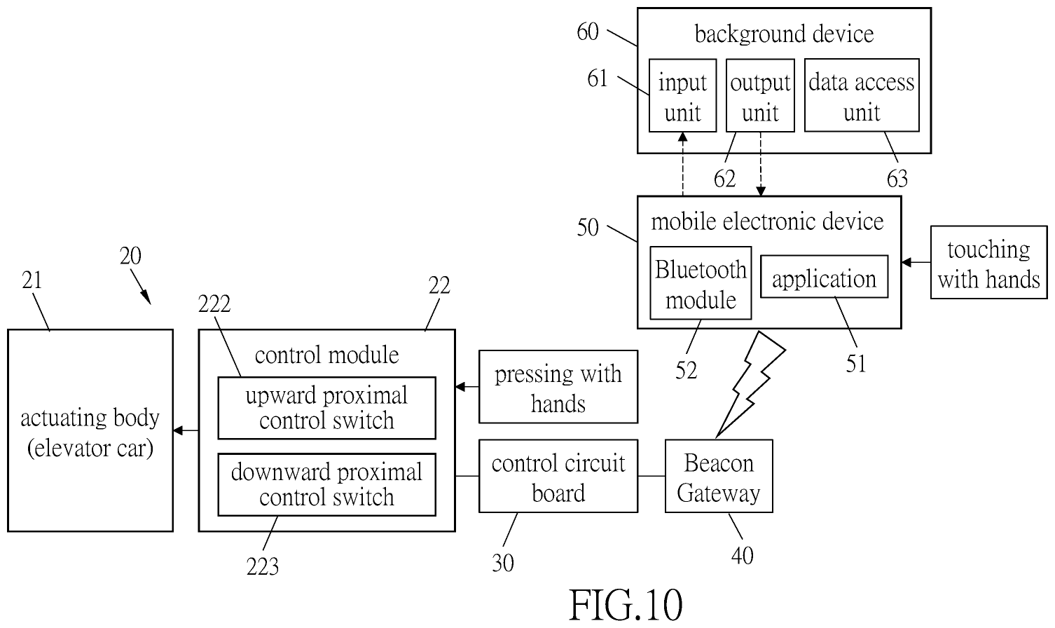

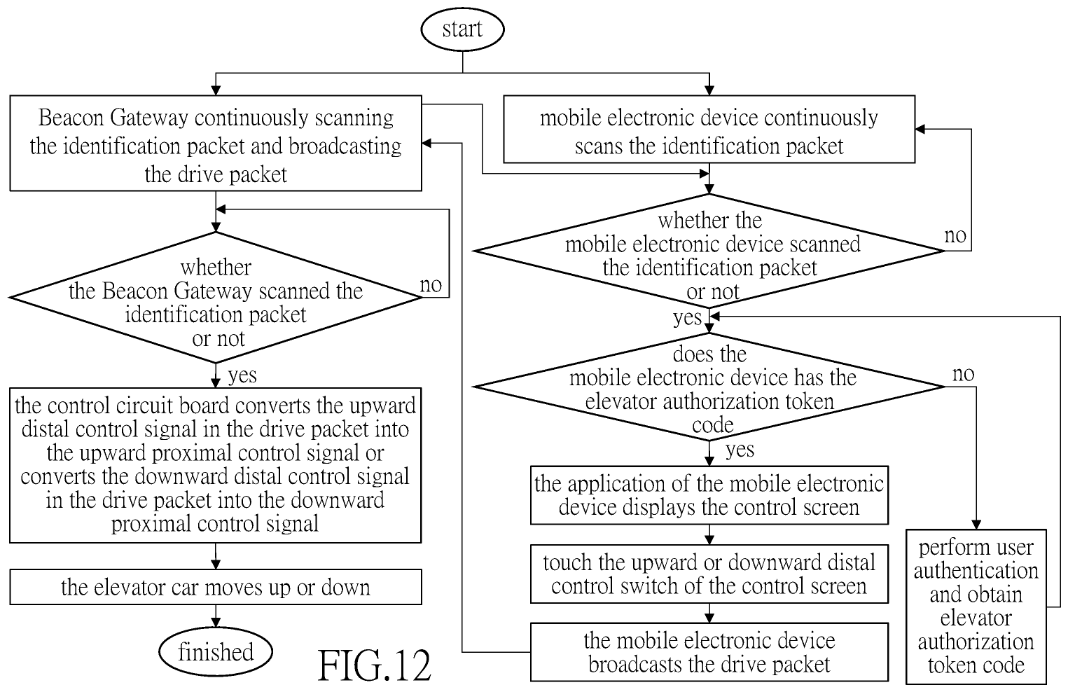

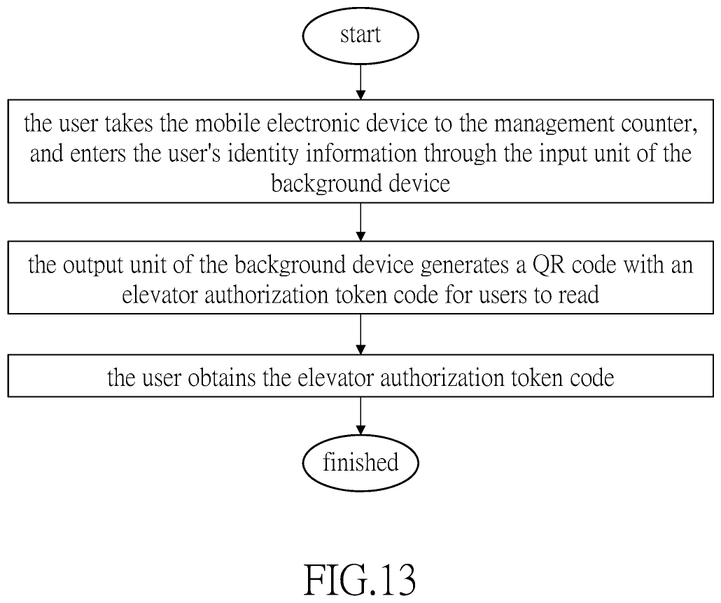

Please refer to FIGS. 10-13, a non-contact control system provided by the fourth embodiment of the present invention is different from the third embodiment in the following aspects:

The application 51 of the mobile electronic device 50 further includes an identity authorization authentication, that is, the application 51 can display the control screen 53 only when the mobile electronic device 50 has the elevator authorization token code inside. The first UUID contains an identification code that requires identity verification control (different from the UUID code of the public elevator in the third embodiment), when the Bluetooth module 52 of the mobile electronic device 50 scans the identification packet broadcasted by the Beacon Gateway 40, the application 51 in the mobile electronic device 50 determines that the first UUID contained in the identification packet has an identification code that requires identity verification control, the application 51 will then first read the elevator authorization token code obtained in advance within the mobile electronic device 50, and after comparing and confirming that the elevator authorization token code has the authority to control the actuating body 21 (ie, the elevator car), the application 51 will display the control screen 53; otherwise, if the mobile electronic device 50 does not obtain the elevator authorization token code, the application 51 will ignore the identification packet broadcasted by the Beacon Gateway 40 and will not display the control screen 53.

As for the above-mentioned identity verification and the obtaining of the elevator authorization token code, please refer to the description as follows: the non-contact control system of the present invention further includes a background device 60 including an input unit 61, an output unit 62, and a Data access unit 63; the input unit 61 is used to read the user's identity data, the output unit 62 generates an elevator authorization token code for the user to obtain, and the data access unit 63 is used to store the Identity information. In this embodiment, the background device 60 uses an application interface (API) as the storage method of the data access unit 63. In addition, the input unit 61 can use QR Code scanning for the user to input the identity data, and the output unit 62 can generate a QR Code for the user to scan the elevator authorization token code.

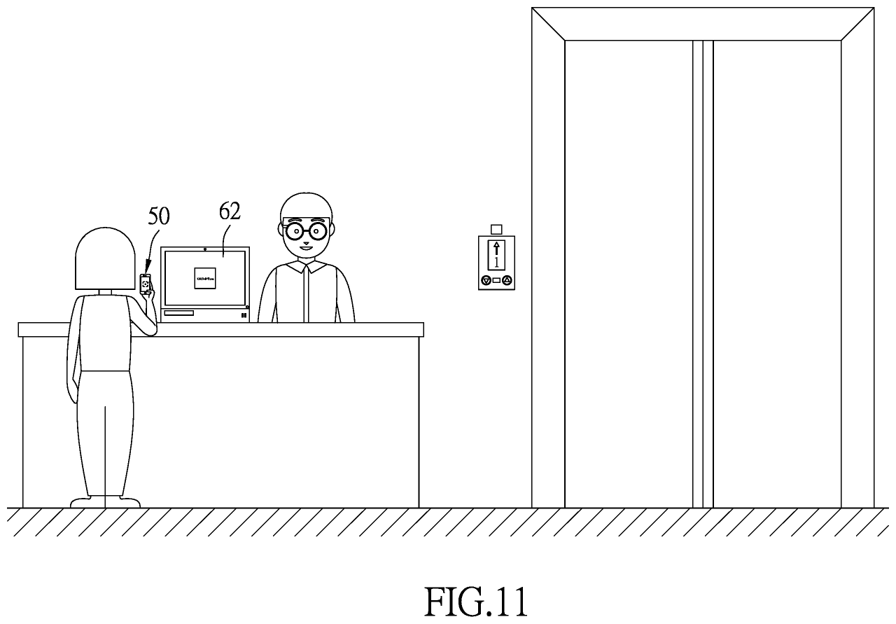

In more detail, before controlling the elevator having identity verification, the user must take the mobile electronic device 50 to the management counter, and input the user's identity data through the input unit 61 of the background device 60. The input method is that the application 51 in the user's mobile electronic device 50 displays a unique personal identification QR Code, such as: International Mobile Device Identification Code (IEMI), mobile phone number, or FB/LINE community account, etc., and the input unit 61 of the background device 60 scans the identity data in the QR Code format displayed by the user. Then, referring to FIG. 11, the administrator uses the output unit 62 generates a QR code with an elevator authorization token code for the user to read or access. At the same time, the data access unit 63 of the background device 60 is used to store the user's identity data with an application interface (API). At this time, after the user scans the elevator authorization token code in QR Code format with the application 51 of the user's mobile electronic device 50, the application 51 of the mobile electronic device 50 then has the elevator authorization token code. When the user is at the elevator landing and wants to control the elevator car 21 that requires identity control, and when the Bluetooth module 52 of the mobile electronic device 50 scans the identification packet with the identification code that requires identity verification control broadcasted by the Beacon Gateway 40, and after comparing and confirming that the elevator authorization token code has the authority to control the actuating body 21 (that is, the elevator car), the application 51 will display the control screen 53, and the user an perform touch control. Since the subsequent control process 15 the same as the third embodiment, it will not be repeated here.

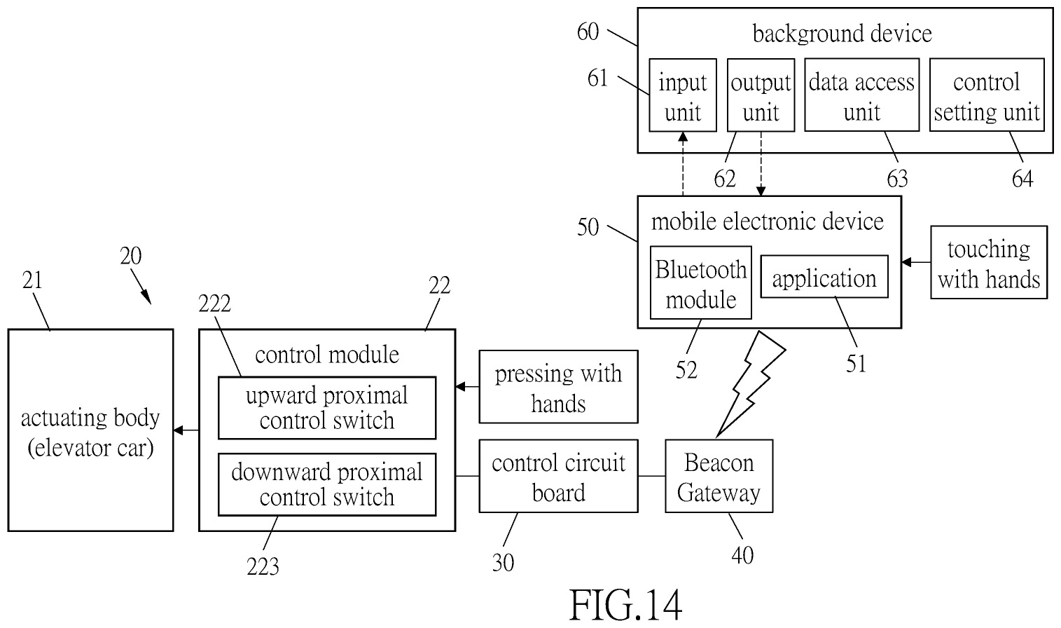

Please refer to FIG. 14, the fifth embodiment of the present invention provides a non-contact control system, which differs from the fourth embodiment in the follows aspects:

The background device 60 further includes a control setting unit 64. After the input unit 61 of the background device 60 scans the identity data in the QR Code format displayed by the user, the administrator uses the control setting unit 64 to set the number and valid period of the elevator car that the user can control (for example, when there are multiple elevator cars, the elevator car that can be controlled to operate is the second elevator car, and the valid period is 3 hours), and the output unit 62 produces a QR code having elevator authorization token code for users to read. Therefore, the elevator authorization token code has three features: the authority to control the actuating body 21 (that is, the elevator car), and the number and the validity period of the user-controllable elevator car, so that when the Bluetooth module 52 of the mobile electronic device 50 scans the identification packet having the identification code that requires identity verification control broadcasted by the Beacon Gateway 40, and after comparing and confirming that the elevator authorization token code has the authority to control the number and the validity period of the elevator car, the application 51 will display the control screen 53 (this screen will only display that the upward distal control switch 532 and the downward distal control switch 533 of the user-controllable elevator car number are operable, the upward distal control switch 532 and the downward distal control switch 533 of the elevator cars of other numbers are highlighted and cannot be operated. Even the countdown state of the valid period is displayed), and the user can control it.

Accordingly, the first UUID of the fifth embodiment contains the identification code for the identification code that requires identity verification control. As for the elevator car-related information (such as elevator car number and validity period), it is stored in the data access unit 63 of the background device 60, unlike the third embodiment where the first UUID only contains the number and floor of the elevator landing, and its main purpose is to facilitate management, setting, and traceability. The description is as follows: because the administrator can first refer to the elevator information of the data access unit 63, and then set the user-controllable elevator car number and valid period through the control setting unit 64, and then the output unit 62 sends the elevator authorization token code to the user's mobile electronic device 50. The elevator authorization token code contains the authority to control the elevator car, the elevator car number, and the valid period. When the user controls the elevator car to move up or down, and after the Bluetooth module 52 of the mobile electronic device 50 scans the identification packet having the identification code that requires identity verification control broadcasted by the Beacon Gateway 40, since the application 51 has the elevator authorization token code, the application 51 will display the control screen 53. Because the data access unit 63 of the background device 60 also stores the user identity data and sets the data, such as the user-controllable elevator car number and validity period, etc. If there are any public safety incidents or the spread of the epidemic in the future, and it is necessary to access the historical footprints of the elevator car that the user has taken within a certain period of time, the design of the background device 60 can make the safest control, record and provide access to footprint information.

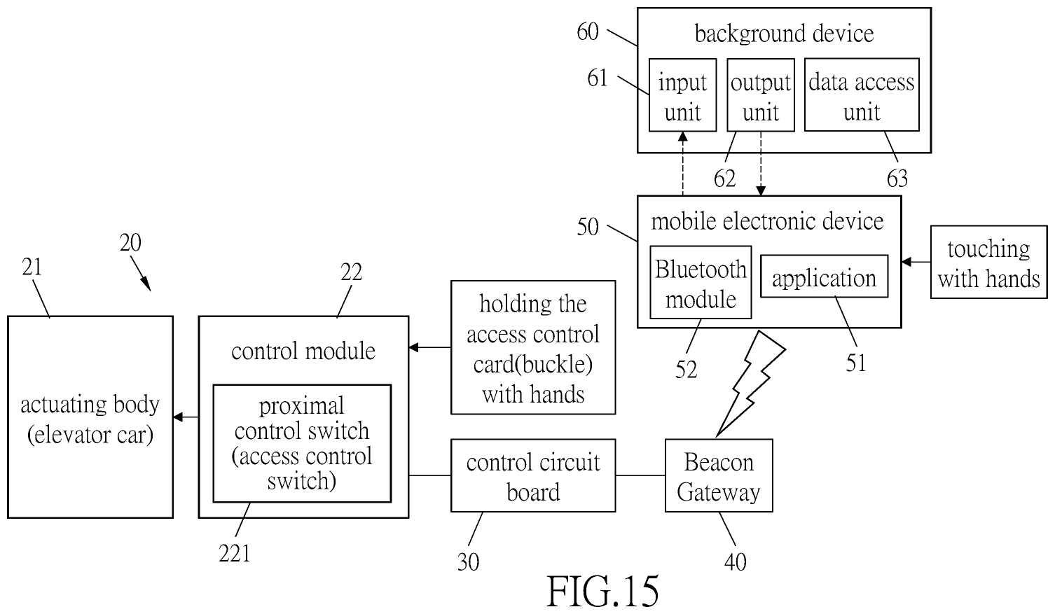

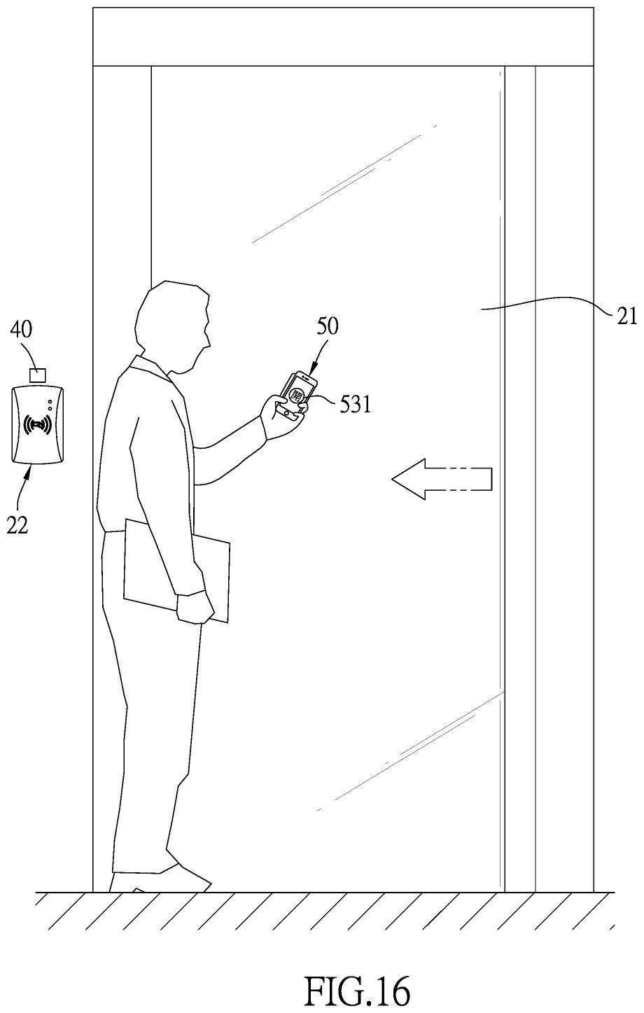

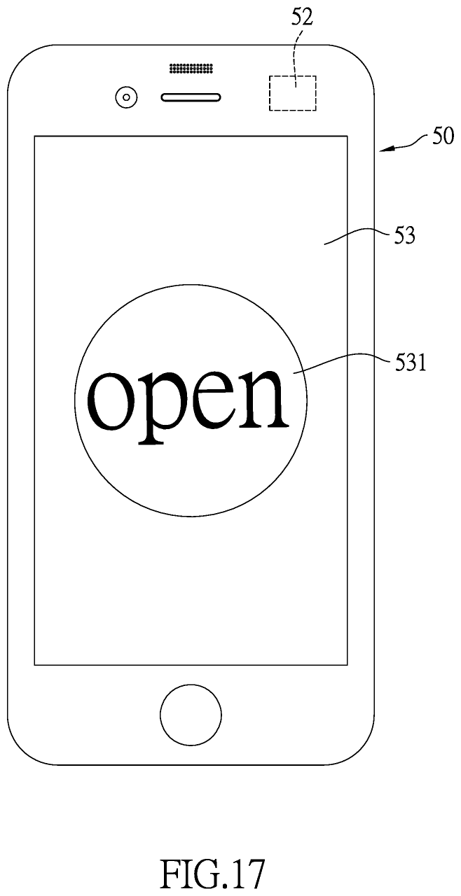

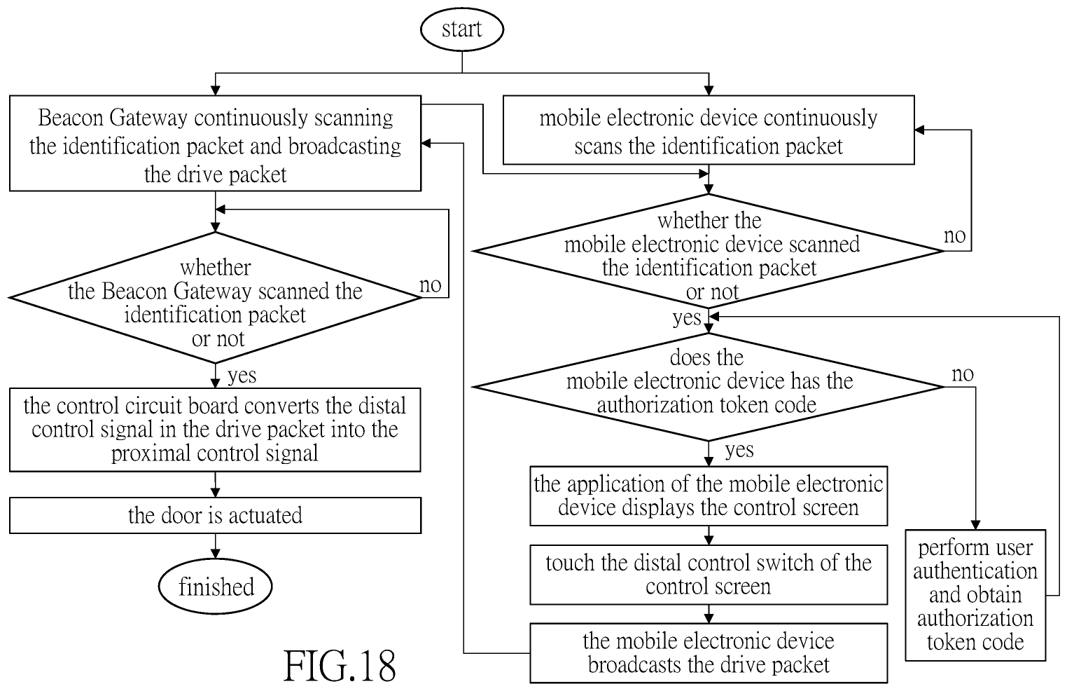

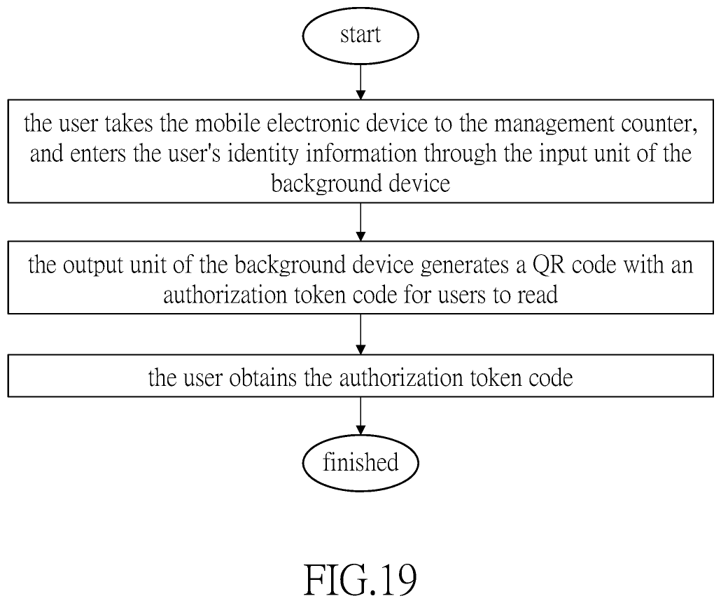

Please refer to FIGS. 15 to 19, the sixth embodiment of the present invention provides a non-contact control system, which is different from the first embodiment in that the device 20 of the sixth embodiment is an access control device. The actuating body 21 is a door. The control module 22 is an access control system, the proximal control switch 221 is an access control switch, and can generate a proximal control signal to control the actuating body 21 to perform a door opening action. The above is the conventional structure of the access control device. The non-contact control system of the present invention also comprises a control circuit board 30, a Beacon Gateway 40, a mobile electronic device 50, and a background device 60.

The control circuit board 30 is electrically connected to the proximal control switch 221 of the control module 22 for converting a distal control signal into a proximal control signal generated by the proximal control switch 221.

The Beacon Gateway 40 is communicatively connected to the control circuit board 30, and continuously broadcasts an identification packet and continuously scans a drive packet. In this embodiment, the identification packet and the drive packet are both in the Bluetooth low energy packet format, the identification packet includes a first UUID, and the drive packet includes a second UUID. The first UUID contains the number of the access control system to avoid the operation of controlling other doors, and the first UUID contains an identification code that requires identity verification control, which is used for access control.

The mobile electronic device 50 is communicatively connected to the Beacon Gateway 40 and is provided with an application 51, and includes a Bluetooth module 52 connected to the application 51. The application also includes an identity authorization authentication. After the mobile electronic device 50 contains the authorization token code inside, the application 51 can display the control screen 53, and the Bluetooth module 52 is used to continuously scan the identification packet and broadcast the drive packet; In the embodiment, the mobile electronic device 50 is a smart phone as an example, and can be wirelessly controlled with the control circuit board 30 without Internet connection.

The background device 60 includes an input unit 61, an output unit 62, and a data access unit 63; since the configuration and operation of the background device 60 are the same as in the fourth embodiment, it will not be repeated.

In this way, when a user wants to enter a place with access control, the user must take the mobile electronic device 50 to the management counter, input the user's identity data through the input unit 61 of the background device 60, and then uses the input unit 61 of the background device 60 to scan the identity data in the QR Code format displayed by the user, and then the administrator uses the output unit 62 to generate a QR code with an authorization token for the user to read. At the same time, the data access unit 63 of the background device 60 is used to store the user's identity data with an application programming interface (API). At this time, after the user scans the authorization token in the QR Code format with the application 51 of the mobile electronic device 50, the application 51 of the mobile electronic device 50 has the authorization token. Therefore, the application 51 of the mobile electronic device 50 can also display the control screen 53. The situation in which the user obtains the authorization token code by using the mobile electronic device 50 can refer to FIG. 11.

After that, when the user holds the mobile electronic device 50 with the authorization token code to a place with the access control, the Bluetooth module 52 of the mobile electronic device 50 scans the identification packet having the identification code that requires identity verification control broadcasted by the Beacon Gateway 40, after comparing and confirming that the authorization token code has the authority to control the operation of the actuating body 21 (ie, the door), the application 51 will display the control screen 53 and the user can perform touch control. That is, the distal control switch 531 displayed on the mobile electronic device 50 is a button for opening the door.

When the user presses the distal control switch 531 displayed on the mobile electronic device 50, the application 51 dynamically generates the drive packet containing the distal control signal, and the distal control signal is the second UUID contained in the drive packet.

Then the application 51 broadcasts the drive packet through the Bluetooth module 52 of the mobile electronic device 50, and when the Beacon Gateway 40 installed in the access control device scans the drive packet and determines that the second UUID contained in the drive packet contains the correct distal control signal information, the Beacon Gateway 40 will send the distal control signal contained in the drive packet to the control circuit board 30. The control circuit board 30 then converts the distal control signal into a corresponding proximal control signal, and the proximal control signal is transmitted to the control circuit board 30. Then, the control module 22 controls the actuating body 21 to act according to the proximal control signal, that is, controls the door to open for the user to enter.

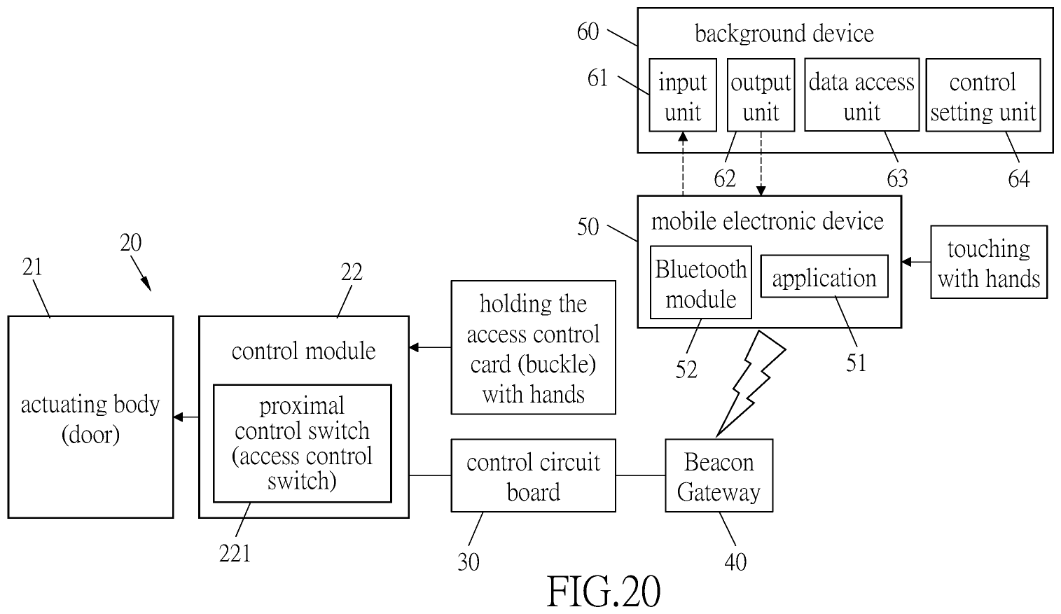

Please refer to FIG. 20, a non-contact control system provided by the seventh embodiment of the present invention is different from the sixth embodiment in the following aspects:

The background device 60 also includes a control setting unit 64, the data access unit 63 is used to store the user's identity data and the user's authority content, the control setting unit 64 is for the administrator to set the user's authority content (such as the validity period), and the output unit 62 generates the authorization token code according to the user's authority content, so that the design of the background device 60 can provide the safest control, record and access footprint information.

While we have shown and described various embodiments in accordance with the present invention, it is clear to those skilled in the art that further embodiments may be made without departing from the scope of the present invention.

What is claimed is:

1. A non-contact control system, suitable for controlling a device, the device including an actuating body and a control module, the control module including a proximal control switch, wherein the proximal control switch is capable of generating a proximal control signal for controlling actuation of the actuating body, the non-contact control system comprising:
a control circuit board electrically connected to the control module for converting a distal control signal into the proximal control signal;
a Beacon Gateway communicatively connected to the control circuit board, and continuously broadcasting an identification packet and an scanning a drive packet; and
a mobile electronic device communicatively connected to the Beacon Gateway, provided with an application, and including a Bluetooth module connected to the application, wherein the Bluetooth module is used for continuously scanning the identification packet and broadcasting the drive packet;
wherein the identification packet and the drive packet are both in a Bluetooth low energy packet format, the identification packet includes a first universally unique identifier, the first universally unique identification code contains number of the device, and the drive packet includes a second universally unique identifier;
in this way, when the application of the mobile electronic device is activated, and the Bluetooth module scans the identification packet broadcasted by the Beacon Gateway, the application of the mobile electronic device analyzes information contained in the identification packet and then displays the control screen of the device with the number, the control screen includes a distal control switch corresponding to the proximal control switch, when the distal control switch is pressed, the drive packet containing the distal control signal is generated, and the drive packet is broadcasted by the Bluetooth module, when the Beacon Gateway scans the drive packet and confirms that the second universally unique identifier is correct, the distal control signal contained in the drive packet is transmitted to the control circuit board, and the control circuit board converts the distal control signal into the proximal control signal corresponding to the proximal control switch, and transmits the proximal control signal to the control module to control the actuating body to act.

2. The non-contact control system as claimed in claim 1, wherein the actuating body is a getting-off-the-bus reminder for reminding a driver, the control module is an exit bell, the proximal control switch is a physical exit bell button, and an actuation method of the actuating body is a light or sound to remind the driver, the first universally unique identifier contains the number of the bus, the control screen pops up through the application, the distal control switch of the control screen is a virtual exit bell button corresponding to the physical exit bell button.

3. The non-contact control system as claimed in claim 1, wherein the actuating body is an elevator car, the control module includes an upward proximal control switch and a downward proximal control switch, the upward proximal control switch is capable of generating an upward proximal control signal for controlling the actuating body to move upward, the downward proximal control switch is capable of generating a downward proximal control signal to control the actuating body to move downward, the first universally unique identifier contains the number and floor of each elevator landing, the control screen pops up through the application, the control screen includes an upward distal control switch corresponding to the upward proximal control switch and a downward distal control switch corresponding to the downward proximal control switch, when the upward distal control switch is pressed, an upward distal control signal is generated, and when the downward distal control switch is pressed, a downward distal control signal is generated.

4. The non-contact control system as claimed in claim 3, wherein the first universally unique identifier contains an identification code that requires identity verification control, the application includes an identity authorization authentication, when the mobile electronic device has an authorization token code inside, the application then displays the control screen.

5. The non-contact control system as claimed in claim 4 further comprising a background device, the background device includes an input unit and an output unit, the input unit is used to read user's identity data, and the output unit generates an authorization token code according to the user's authority content.

6. The non-contact control system as claimed in claim 5, wherein the background device further includes a data access unit and a control setting unit, the data access unit is used to store the user's identity data and the user's authority content, the control setting unit is for an administrator to set the user's authority content, and the output unit generates the authorization token code according to the user's authority content.

7. The non-contact control system as claimed in claim 1, wherein the first universally unique identifier contains an identification code that requires identity verification control, the application includes an identity authorization authentication, when the mobile electronic device has an authorization token code inside, the application then displays the control screen, the actuating body is a door, the control module is an access control system, the proximal control switch is an access control switch and capable of generating a proximal control signal to control the actuating body to perform a door opening action, the first universally unique identifier contains the number of the access control system, the control screen pops up through the application, the control screen includes a door-opening distal control switch corresponding to the proximal control switch of the access control system, and when the door-opening distal control switch is pressed, a door-opening distal control signal is generated.

8. The non-contact control system as claimed in claim 7 further comprises a background device, the background device includes an input unit and an output unit, the input unit is used to read user's identity data, and the output unit generates an authorization token code according to the user's authority content.

9. The non-contact control system as claimed in claim 8, wherein the background device further includes a data access unit and a control setting unit, the data access unit is used to store the user's identity data and the user's authority content, the control setting unit is for an administrator to set the user's authority content, and the output unit generates the authorization token code according to the user's authority content.
